(19) United States
(12) Patent Application Publication
(10) Pub. No.: US 2008/0178745 A1
(43) Pub. Date: Jul. 31, 2008

(54) GRILLING SYSTEM AND TABLE EQUIPPED WITH THE GRILLING SYSTEM

(76) Inventor: Gil Mong HONG, Seoul (KR)

Correspondence Address: KED & ASSOCIATES, LLP, P.O. Box 221200, Chantilly, VA, 20153-1200, US

(21) Appl. No.: 12/014,257

(22) Filed: Jan. 15, 2008

(30) Foreign Application Priority Data
Jan. 29, 2007 (KR) 20-2007-0001624
Jul. 4, 2007 (KR) 10-2007-0067254

(51) Int. Cl. A47J 37/06; A47J 37/07; F24B 3/00; F24C 15/00; A47B 37/00

(52) U.S. Cl. 99/357; 99/324; 126/25 R; 99/446; 99/450; 99/447; 108/50.13

(57) ABSTRACT

A table equipped with a grilling system is provided. The table may include an opening, and a housing coupled to the table and having an opening in an upper portion thereof through which heat may be transferred to the opening in the table. Inclined lateral sides may extend upward from a bottom of the housing. Heat-source containers that contain a heat source may be coupled to the lateral sides. Holes formed on a bottom of the heat-source containers may be aligned with a plurality of holes formed in the lateral sides to allow air flow into the heat source containers, where the air is heated and drawn up and out through the opening in the upper portion of the housing.

This application claims the benefit of Korean Patent Application No. 20-2007-0001624 filed in Korea on Jan. 29, 2007 and Korean Patent Application No. 10-2007-0067254 filed in Korea on Jul. 4, 2007, the entirety of which are hereby incorporated herein by reference.

### BACKGROUND

1. Field

This relates to a cooking system, and in particular to a grilling system in which heat is evenly generated and transferred towards food to be cooked.

2. Background

Grilling systems are widely used in both home and commercial applications for cooking various types of food. Fast, effective, efficient transfer of heat from a heat source to a grilling surface of these grilling systems provides for fast and even cooking of food positioned on the grilling surface.

### BRIEF DESCRIPTION OF THE DRAWINGS

The embodiments will be described in detail with reference to the following drawings in which like reference numerals refer to like elements wherein:

FIG. 1 is a top view of an exemplary table equipped with a grilling system as embodied and broadly described herein;

FIG. 2 is a perspective view of a grilling system in accordance with an embodiment as broadly described herein;

FIG. 3 is a cross-sectional view of a table equipped with the grilling system shown in FIG. 2;

FIG. 4 is a top view of a heat-source container of the grilling system shown in FIGS. 2 and 3;

FIG. 5 is a cross-sectional view of the heat-source container shown in FIG. 4;

FIG. 6 is a cross-sectional view of an exemplary table equipped with a grilling system in accordance with another embodiment as broadly described herein; and

FIG. 7 is a cross-sectional view of an exemplary table equipped with a grilling system in accordance with another embodiment as broadly described herein.

### DETAILED DESCRIPTION

Grilling systems may be used to cook, or grill, various types of food, such as, for example, meat, in a restaurant or home application. Such a grilling system may include an upper opening covered by a grating or other such grilling surface on which food items are placed for cooking. A heat source, such as, for example, charcoal, may be positioned at a bottom portion of the grilling system, beneath the upper opening, and heat generated by the heat source may be directed upward to heat the food on the grating and quickly cook the food. However, juices, fat, spices and the like from the food being grilled on the grating may drop onto the heat source during grilling, thereby generating smoke and odors.

An air intake or exhaust system including, for example, a duct or a pipe, may be used to forcibly discharge any smoke and/or odors generated during grilling. However, installation of such an air intake and/or exhaust system may be costly and may not guarantee complete discharge of the smoke and odors generated during grilling. Smoke and odors may also damage the interior of the kitchen. Furthermore, smoke discharged to the outside may contaminate the atmosphere. In addition, when the generated smoke rises up through the grating, it contacts the food being cooked, and may transfer harmful elements included in the smoke to the food.

One way to minimize the amount of smoke generated during grilling is to prevent juices, fat, spices and the like from contacting the heat source. The heat source may be offset from the upper opening over which the grating is positioned, to prevent juices, fat and spices from dropping onto the heat source and reacting with the heat source. However, this offset placement of the heat source, by itself, may be ineffective in transferring a strong, even amount of heat toward the grating that is adequate to cook the food.

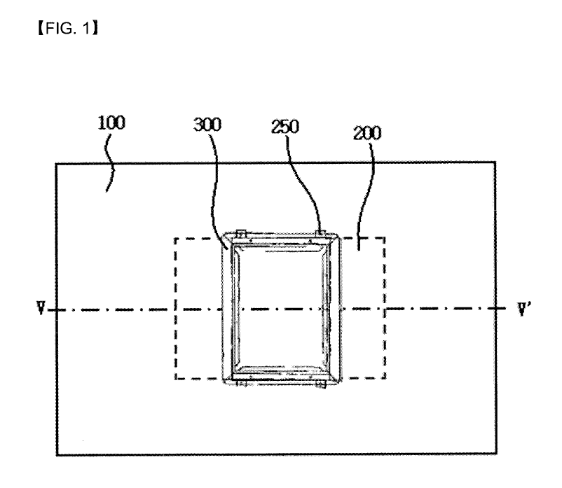

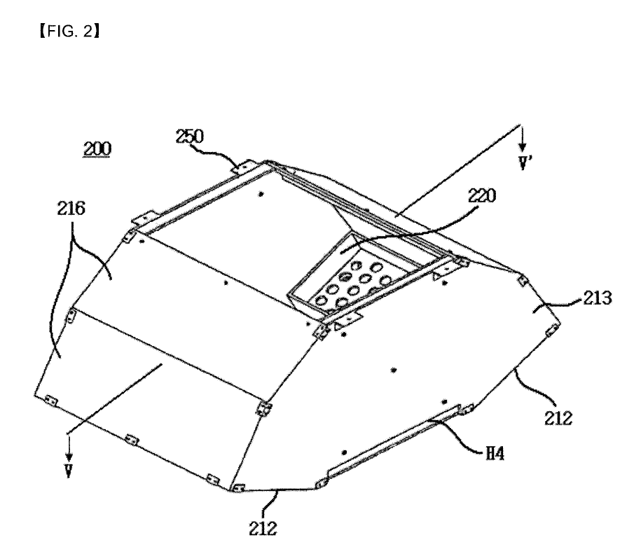

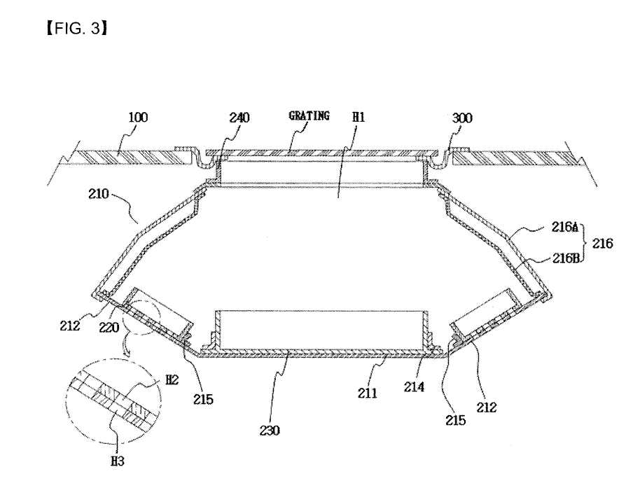

To address these issues, as shown in FIGS. 1-3, a grilling system 200 in accordance with an embodiment as broadly described herein may be fitted to a table 100 having an opening formed therein. Although the structure that supports/surrounds the grilling system 200 is referred to as a table 100 for ease of discussion, it is well understood that the grilling system 200 may be coupled to a number of different types of surfaces appropriate for cooking/grilling applications, both indoor and outdoor, stationary and portable.

A housing 210 may be held in place under the opening in the table 100. In certain embodiments, the housing 210 may be attached to the underside of the table 100 by holding plates 250 using fasteners such as, for example, nails, screws, nuts-and-bolts, two-side access supported rivets, one-side access blind rivets, quick-release fasteners and the like. Other fasteners may also be appropriate. Likewise, the holding plates 250 may be coupled to the housing 210 by various methods, including, for example, by welding, or soldering, or with various types of discrete fasteners including nails, screws, nuts-and-bolts, two-side access supported rivets, one-side access blind rivets, quick-release fasteners, and others as appropriate.

The grilling system 200 may have an opening in an upper portion thereof through which heat generated within the housing 210 may be directed. A grating support plate 300 may extend either partially or fully along the inner circumference of the opening in the table 100 to support the grating. In certain embodiments, an upper portion of the grating support plate 300 may extend up and over the table 100. Other arrangements may also be appropriate. Likewise, the grating support plate 300 may be four-cornered, circular, or have another contour as appropriate for a particular application. The grating support plate 300 may have an opening in the middle so that a grating positioned thereon is exposed to the housing 210 positioned below.

The housing 210 may include an upper opening H1 through which heat may be directed toward the grating. The housing 210 may include a bottom 211 and a pair of first inclined lateral sides 212 extending upward at an incline from opposite side edges of the bottom 211. In certain embodiments, each of inclined lateral sides 212 makes an obtuse angle with the bottom 211.

In certain embodiments, a heat-source container 220 may be provided on each of the first inclined lateral sides 212 of the housing 210. In alternative embodiments, a heat source container 220 may be provided on only one of the first inclined lateral sides 212, or multiple heat source containers 220 may be provided on one of or both or the first inclined lateral sides 212. A water container 230 may be provided on the bottom 211 of the housing 210. When so arranged, the heat-source containers 220 do not directly face the grating so that juices, fat and spices on the grating drop instead into the water container 230 positioned on the bottom 211, rather than into the heat source containers 220. Avoiding contact between these juices, fat, and spices with the heat source prevents smoke from being generated.

The heat-source containers 220 may be freely attachable to and detachable from the first inclined lateral sides 212 of the housing 210 to facilitate their removal, replacement, replenishment, repair and/or maintenance of the heat source contained therein as necessary. For example, heat-source containers 220 may be placed on and removed from the first inclined lateral sides 212 of the housing 210 through the opening H1. The heat-source container may contain charcoal, wood or other heat generating source including gas burners, gas jet, electric heat sources, etc.

An opening H4 may be provided on a front side 213 of the housing 210, or on another side of the housing 210 as appropriate. For example, the opening H4 may be provided on a back side of the housing 210. The water container 230 may be introduced into the housing 210 through the opening H4 and positioned on the bottom 211 of the housing 210. The water container 230 may collect any juices, oil and spices which may drop from the grating. The water container 230 may slide into and out of the housing 210 along a pair of guides 214 provided on the bottom 211 of the housing 210 that guide the sliding motion of the water container 230. For this purpose, the opening H4 may be shaped and sized so that a corresponding side of the water container 230 may form a substantially airtight closure of the opening H4 when the water container 230 positioned in the housing 210. In this manner, insertion of the water container 230 into the housing 210 along the guides 214 may substantially prevent air flow between the opening H4 and the housing 210.

A plurality of first holes H2 may be formed on the bottom of each of the heat-source containers 220. A plurality of second holes H3 may be formed on corresponding regions of the first inclined lateral sides 212. Thus, the heat-source containers 220 may be placed on the first inclined lateral sides 212 such that the first holes H2 in the bottom of the heat-source containers 220 are aligned with the corresponding second holes H3 in the first lateral sides 212. This allows for free passage of air from the second holes H3, through the first holes H2, to the upper opening H1. A supporting plate 215 may be provided on each of the first inclined lateral sides 212 to support and hold the heat-source containers 220 in place and align the first holes H2 with the second holes H3.

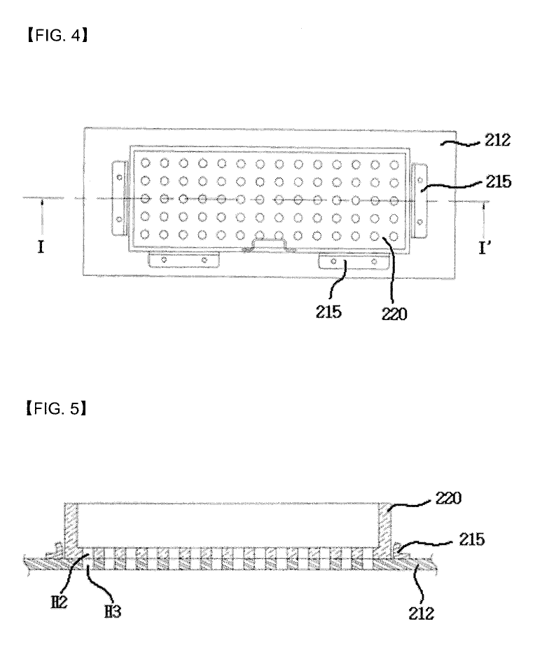

As shown in more detail in FIGS. 4 and 5, in certain embodiments the second holes H3 may be substantially the same as the first holes H2 in size and location. As a result, the second holes H3 may correspond to the first holes H2, hole for hole, when the heat-source container 220 is appropriately positioned on the first inclined lateral side 212. This enables free passage of air from the second holes H3, through the first holes H2, to the upper opening H1. In alternative embodiments, sizes of second holes H3 may be larger than those of first holes H2, and vice versa. Similarly, one or more larger-sized circular or rectangular openings may be formed in a portion of the first inclined lateral sides 212 corresponding to the first holes H2, allowing free passage of air. In this case, at least a portion of the heat-source containers 220 are supported by the first inclined lateral side 212. For example, one or two rectangular holes H3 may be formed in the first inclined lateral sides 212 corresponding to the plurality of first holes H2. The first and second holes H2 and H3 may be variable in number and size as long as free passage of air, which provides natural air convection, is allowed from the second holes H3 through the first holes H2 to the upper opening H1.

In certain circumstances, heat generated by the heat sources may not be uniform when it reaches the grating. More specifically, heat may be weaker at a middle of the grating than at other regions of the grating. By making the housing 210 of the grilling system 200 substantially airtight, except for the first and second holes H2 and H3 and the upper opening H1, complete air passage through natural air convection provides even heat transfer and minimizes heat loss. However, when the housing is not airtight, outside air may be introduced into the housing 210 without being heated. This lowers heating efficiency and reduces a temperature of the air directed toward the middle of the grating. By ensuring that outside air is introduced into the housing through the first and second holes H2 and H3, all of the outside air passes through the heat source and is heated before it reaches the grating.

As set forth above, the housing 210 may be substantially airtight, except for the upper opening H1, the second holes H3, and the opening H4. In this context, “substantially airtight” may mean, for example, “unintentionally allowing a very small amount of air to enter or escape,” as well as “completely preventing the entrance or escape of air.” In fabricating the housing 210, a variety of parts may be connected or assembled by, for example, welding, or soldering, or with various types of discrete fasteners such as, for example, nails, screws, nuts-and-bolts, two-side access supported rivets, one-side access blind rivets, and quick-release fasteners. In so doing, apertures may unintentionally exist between two connected parts and thus the housing 210 may not be completely airtight. However, the very small amount of air into and out of the housing 210 through such apertures would not have a significant impact on characteristics of the grilling system 200 as embodied and broadly described herein.

The structure of the grilling system 200 shown in FIGS. 1-5 enables transfer of heat from a heat source contained in the heat source containers 220 toward the upper opening H1 of the housing 210 by natural air convection. Also, the structure of the grilling system 200 shown in FIGS. 1-5 provides free air passage from the second holes H3, through the first holes H2 and the heat source, where it is heated, and then up to the upper opening H1. As outside air enters through the first and second holes H2 and H3 and comes in contact with the heat source, the air is heated and then flows into the housing 210. The heated air is directed up towards the upper opening H1 in the housing 210, where it heats food on the grating. This makes it possible to direct strong, even heat toward the grating and minimize heat loss. The grilling system 200 shown in FIGS. 1-5, having heat sources on both of the inclined lateral sides 212, may also minimize generation of smoke during grilling.

The heat-source containers 220 may be provided on the first inclined lateral sides 212 which each form an obtuse angle with the bottom 211 of the housing 210. As a result, the heat-source containers 220 may obliquely face the upper opening H1 of the housing 210, thus increasing efficiency in transfer of heat toward the grating. In certain embodiments, a height of each heat-source container 220 may be greater than that of its corresponding heat source to increase efficiency in transfer of heat toward the grating.

The housing 210 may also include a pair of second inclined lateral sides 216, respectively connected to upper edges of the first inclined lateral sides 212, and forming acute angles with respect to the bottom 211. The second inclined lateral sides 216 may each include an external plate 216A and an internal plate 216B. The internal plate 216B may include a reflector that reflects incident heat toward the upper opening H1 to increase efficiency in transfer of heat toward the grating. The internal plate 216B may be made of stainless steel, or other material as appropriate for the particular application. The dual-plate structure of the second inclined lateral sides 216 may function as a heat insulator. In alternative embodiments, the other sides of the housing 210 may have a similar dual-plate structure with a thin air space formed between the two plates to provide further heat insulation.

A heat guider 240 may be provided on the upper end of the housing 210. The heat guider 240 may guide heat from the upper opening H1 toward the grating, and may correspond to an edge of the opening in the table 100 to support the grating support plate 300 on which the grating is positioned.

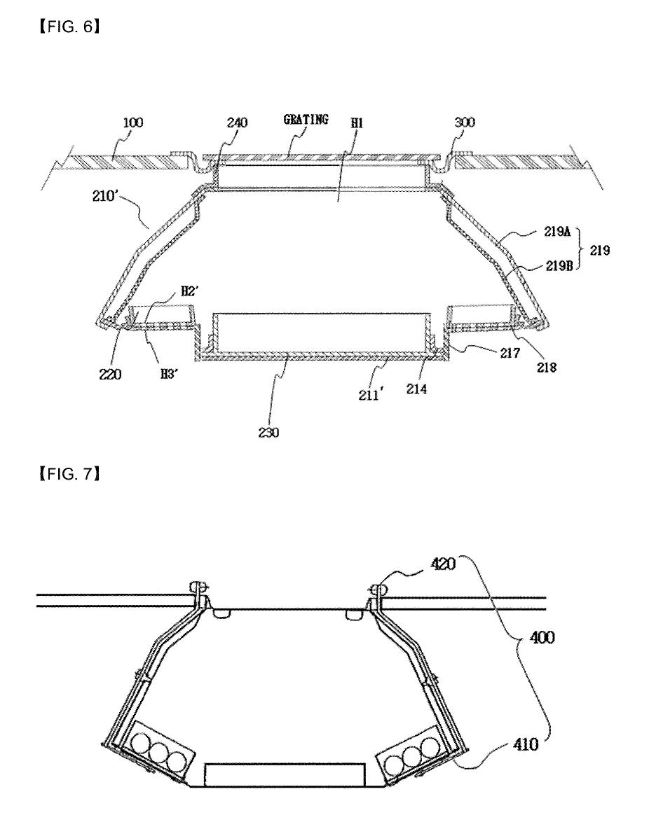

FIG. 6 is a cross-sectional view of an exemplary table equipped with a grilling system 200′ in accordance with another embodiment as broadly described herein. The grilling system 200′ may include a housing 210′ having vertical sides 217 extending vertically from respective edges of the bottom 211′, horizontal sides 218 extending horizontally respective edges of the vertical sides 217 and parallel to the bottom 211′, and inclined lateral sides 219 extending from respective edges of the horizontal sides 218 and making an acute angle with the bottom 211′. A plurality of first holes H2′ may be formed in a bottom of each heat-source container 220′. A plurality of second holes H3′, which correspond to the plurality of first holes H2′, may be formed on the horizontal sides 218. The first holes H2′ may be individually aligned with the second holes H3′. The heat-source containers 220 may be positioned on the horizontal sides 218 of the housing 210′. During grilling, the first holes H2′ may be individually aligned with the second holes H3′. Location of the heat-source containers 220 on the horizontal sides 218, instead of the inclined lateral sides 219 as in the embodiment shown in FIGS. 1-5, facilitates removal and replacement of the heat-source containers 220 from the housing 210′, while the heat source containers 220 remain offset from the grating.

FIG. 7 is a cross-sectional view of an exemplary table equipped with a grilling system in accordance with another embodiment as broadly described herein, including an air flow controller 400, in addition to the above described elements of the embodiment shown in FIGS. 1-5. The air flow controller 400 may include an air blocking plate 410 that selectively opens and closes the plurality of second holes H3 formed on the first inclined lateral sides 212, and an air flow control lever 420 that controls movement of the air blocking plate 410. The air flow controller 400 allows an amount of heat directed to the grating to be regulated by controlling an amount of air that enters the housing 210.

A grilling system that minimizes generation of smoke during grilling and a table equipped with the grilling system are provided.

A grilling system that transfers strong heat evenly toward a gridiron, minimizes generation of smoke during grilling and a table equipped with the grilling system as provided.

A grilling system that transfers strong heat evenly toward a gridiron, and allows a heat source to be put in and taken out with convenience and a table equipped with the grilling system are provided.

In accordance with an embodiment as broadly described herein, a grilling system may include a housing having an upper opening which heat is transferred toward, the housing including a bottom and a lateral side coupled to an edge of the bottom, and a heat-source container for containing heat source, attachable to and detachable from the lateral side, and wherein a plurality of first holes is formed on a bottom of the heat-source container and a second hole is formed on a first region of the lateral side, the first region corresponding to the bottom of the heat-source container.

In accordance with another embodiment as broadly described herein, a table equipped with a grilling system may include a table having an upper opening in the middle, a housing having an upper opening which heat is transferred toward, the housing including a bottom and a lateral side coupled to an edge of the bottom, a holding plate holding the housing in place under the table, and a heat-source container for containing heat source, attachable to and detachable from the lateral side, wherein a plurality of first holes is formed on a bottom of the heat-source container and a plurality of second holes is formed on a first region of the lateral side, which corresponds to the bottom of the heat-source.

Any reference in this specification to “one embodiment,” “an embodiment,” “example embodiment,” “certain embodiment,” “alternative embodiment,” etc., means that a particular feature, structure, or characteristic described in connection with the embodiment is included in at least one embodiment as broadly described herein. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A grilling system, comprising:
a housing having an opening formed in an upper portion thereof, a bottom side positioned opposite the opening, and a pair of lateral sides coupled to opposite edges of the bottom side; and
a heat-source container removably coupled to each of the pair of lateral sides, wherein each heat source container includes a plurality of first holes formed in a bottom surface thereof, and each of the lateral sides includes at least one second hole formed in a portion thereof corresponding to the bottom of the respective heat-source container coupled thereto.

2. The grilling system according to claim 1, wherein the housing further comprises a front side having an opening that slidably receives a water-container into and out of the housing.

3. The grilling system according to claim 2, wherein a shape and size of the opening in the front side of the housing corresponds to a shape and a size of a front side of the water container such that an interface therebetween is substantially airtight when the water container is positioned within the housing.

4. The grilling system according to claim 1, further comprising a supporting plate provided on each of the lateral sides, wherein the supporting plate holds the heat-source container in place on its respective lateral side so as to align the plurality of first holes formed in the heat source container with the at least one second hole formed in the respective lateral side.

5. The grilling system according to claim 4, further comprising a cooking surface that extends across the opening in the upper portion of the housing, wherein heat generated by the heat sources contained in the heat source containers is directed upward through the opening in the housing to heat the cooking surface.

6. The grilling system according to claim 5, wherein the first and second holes direct air into the heat source containers for heating by the heat sources and then upward through the opening in the upper portion of the housing.

7. The grilling system according to claim 6, wherein the cooking surface comprises a grating having a plurality of openings formed therein, wherein heated air is drawn upward through the opening in the upper portion of the housing and through the plurality of openings in the grating so as to heat the grating and a food item positioned thereon.

8. The grilling system according to claim 1, further comprising a heat guider provided at an upper end of the housing proximate the opening, wherein the heat guider guides heat from the opening in the housing toward a cooking surface positioned atop the housing.

9. The grilling system according to claim 1, wherein each lateral side comprises a first inclined surface that forms an obtuse angle with the bottom side of the housing.

10. The grilling system according to claim 9, further comprising a second lateral side extending from an upper edge of each of the first lateral sides, wherein each of the second lateral sides comprises a second inclined surface that forms an acute angle with respect to the bottom side of the housing.

11. The grilling system according to claim 10, wherein each of the second lateral sides comprises an external plate and an internal plate.

12. The grilling system according to claim 11, wherein the internal plate is made of a material that reflects incident heat.

13. The grilling system according to claim 1, wherein the housing has a dual plate structure comprising two plates having an air space formed therebetween that provides for thermal insulation between an interior and an exterior of the housing.

14. The grilling system according to claim 1, wherein the at least one second hole in each of the lateral sides comprises a plurality of second holes that directly correspond the plurality of first holes formed in the bottom of the heat source containers.

15. The grilling system according to claim 14, further comprising a flow controller that controls a flow of air through the first and second holes and into the housing, wherein the flow controller comprises:
an air blocking plate that selectively opens and closes the plurality of second holes so as to control amount of air entering the housing through the first and second holes; and
a control lever that controls movement of the air blocking plate.

16. The grilling system according to claim 1, wherein each lateral side of the housing comprises a vertical side that extends vertically from a corresponding edge of the bottom side, a horizontal side that extends horizontally outward from a corresponding edge of the vertical side, substantially parallel to the bottom side, and an inclined lateral side from a corresponding edge of the horizontal side so as to form an acute angle with the bottom side, wherein the heat source containers are positioned on the horizontal sides.

17. The grilling system according to claim 16, further comprising a water container positioned on the bottom side of the housing, facing a grating that extends across the opening in the upper portion of the housing, wherein the heat source containers are positioned at an offset relative to the opening in the upper portion of the housing.

18. The grilling system according to claim 17, wherein a length, width and position of the water container corresponds to a length, width and position of a grating that extends across the opening such that drippings from food positioned on the grating drop into water in the water container during grilling.

19. A table equipped with a grilling system, comprising:
a table having an opening formed therein;
a housing having an opening formed in an upper portion thereof, a bottom side opposite the opening, and a pair of lateral sides coupled to opposite edges of the bottom side;
a holding plate that couples the housing and the table at the respective openings thereof; and
a pair of heat-source containers that each contain heat source, wherein the pair of heat source containers are removably coupled to the pair of lateral sides, wherein a plurality of first holes is formed in a bottom surface of each of the heat-source containers, and a plurality of second holes is formed in portions of the lateral sides corresponding to the bottom surfaces of the heat-source containers coupled thereto.

20. The table equipped with a grilling system according to claim 19, further comprising a heat guider provided at an upper end of the housing, wherein the heat guider guides heat from the opening in the housing toward a cooking surface extending across the opening in the table.

21. The grilling system according to claim 20, wherein the pair of heat source containers are positioned at an offset relative to the cooking surface.

22. The grilling system according to claim 21, wherein the plurality of first and second holes guide air into the heat source containers for heating by the heat sources and then up through the opening in the housing to the cooking surface.

23. The grilling system according to claim 22, further comprising a water container provided on the bottom side of the housing, wherein a size, shape and location of the water container corresponds to a size, shape and location of the opening such that drippings generated during grilling of food items on the cooking surface drop into the water container.
